(19) United States
(12) Patent Application Publication
(10) Pub. No.: US 2015/0090671 A1
(43) Pub. Date: Apr. 2, 2015

(54) USE OF AN ACID SCAVENGER TO INCREASE THE RESISTANCE OF A POLYOLEFIN COMPOSITION AGAINST DISINFECTANT CONTAINING WATER

(71) Applicant: BOREALIS AG, Wien (AT)

(72) Inventors: Thomas Hjertberg, Kungshamn (SE); Jeroen Oderkerk, Stenungsund (SE); Francis Costa, Linz (AT); Anh Tuan Tran, Luftenberg (AT)

(73) Assignee: Borealis AG, Vienna (AT)

(21) Appl. No.: 14/402,411

(22) PCT Filed: Jun. 10, 2013
(86) PCT No.: PCT/EP2013/001692

§ 371 Date: Nov. 20, 2014

(30) Foreign Application Priority Data
Oct. 24, 2012 (EP) 12007305.0

(51) Int. Cl. C08K 3/26; C08K 5/1545; C08K 5/134; C08K 5/13; C02F 1/76; F16L 57/02

(52) U.S. Cl. CPC C08K 3/26; C02F 1/76; F16L 57/02; C08K 5/1345; C08K 5/13; C08K 5/1545
USPC 210/754

(57) ABSTRACT

The present invention relates to the use of an acid scavenger to increase the resistance of a polyolefin composition against disinfectant containing water. The present invention further relates to a method for transporting water containing a disinfectant comprising the step of conveying the water through a pipe comprising a polyolefin composition, the polyolefin composition comprising an acid scavenger.

The present invention relates to the use of an acid scavenger to increase the resistance of a polyolefin composition against disinfectant containing water. The present invention further relates to a method for transporting water containing a disinfectant comprising the step of conveying the water through a pipe comprising a polyolefin composition, the polyolefin composition comprising an acid scavenger.

Recent progresses in the manufacturing and processing of polymers have led to the application of plastics in virtually every aspect of modern day life. Besides many other applications, polyolefins are used for the preparation of pipes, fittings or storage containers for drinking water distribution systems. In the following disclosure all characteristics and effects supplied to pipes are also supplied to fittings and storage containers, even if not mentioned specifically. To ensure that the drinking water intended for human consumption is of good quality, disinfection is often used. Disinfection means the removal, deactivation or killing of pathogenic microorganisms.

It is known that chlorine is used as disinfectant in water treatment to prevent spread of infectious diseases.

It is also known that most materials, including many polymers such as polyolefins, may be affected by chlorinated water. Results from pressure testing in laboratories and experience from the field have shown that high concentration of chlorine in water can cause early brittle fracture in polyolefin pipes.

An effective alternative disinfectant for drinking water systems is chlorine dioxide, (ClO₂). Chlorine dioxide is a stronger oxidizing agent than chlorine and does not form halogenated by-products. It does not hydrolyze in water but remains in solution as a dissolved gas. Polyolefin resins have shown to have a lower lifetime in chlorine dioxide containing water than in chlorine containing water. Thus, chlorine-resistant polyolefin resins may not be resistant against chlorine dioxide.

Nevertheless, also chlorine dioxide containing water is in permanent contact with the polymeric material. Due to the permanent contact to the inner surface of the polymeric material, deterioration of the polyolefin composition is caused.

It has been found that additives used in polyolefin compositions for pipes known to provide a good resistance to chlorinated water do not necessarily provide satisfactory resistance against chlorine dioxide-containing water. Thus, there is still a need for a more efficient additive, which besides good protection against chlorine containing water, provides also good protection against ClO₂ containing water. Thus allows a longer lifetime of an article, e.g. a pipe, a fitting or a storage container made from a polyolefin composition containing such an additive.

A further important issue as regards the presence of additives in polyolefin compositions is the aim to avoid contamination of media transported e.g. in a pipe made of such a polyolefin composition. This is particularly important in case of a pipe transporting drinking water. Generally speaking, it is preferred to use as low concentrations of additives as possible in order to lower the amount of antioxidant which may possibly be extracted from the pipe into the transported water. Further in this context, it is desirable that the additives used has a low tendency to extraction from the pipe to the transported water.

The admissible amounts of harmful compounds within the drinking water are fixed by legal requirements and even stricter requirements are to be expected with the introduction of the so-called “European acceptance scheme”.

Migration behavior of additives, such as stabilizers and modifiers, added to polyolefin-based materials is dependent from a number of different properties such as diffusion rate of the molecules within the polymer matrix, chemical stability of the additives, type of additive decomposition products, etc. To give an example, a specific additive compound might have improved chemical stability, thereby having a beneficial effect on migration behavior. Other less stable additive compounds might, on the other hand, decompose into compounds easily diffusing through the polymer matrix, thereby having a detrimental effect on migration behavior. Furthermore, it has to be taken into account that an improvement in migration behavior must not be obtained on the expense of stabilization of the polymer matrix.

However, to further improve drinking water quality and considering stricter legal requirements to be expected in the near future, it is still highly appreciated to provide polymeric materials of high thermal and chemical stability.

EP 1 911 798 A1 discloses a composition comprising a polyolefin (A); a compound (B) which has a diphosphite structure; c) a phenolic compound (C); and d) optionally, an UV-light stabilizer (D), wherein the total amount of migrated compounds (B), (C) and, if present, (D), as well as their decomposition products are below certain threshold levels in the composition. The composition shows reduced migration of additives into water in contact with composition samples which were leached with unchlorinated water according to EN-12873-1 at room temperature (23° C.).

EP 2 199 330 A1 relates to a polyolefin composition with good resistance to degradation caused by chlorine dioxide-containing water and at the same time showing low migration of the used additives and its decomposition products, especially phenols, out of the composition. The polyolefin composition comprises a polyolefin base resin (A), an antioxidant (B) having a chroman-6-ol structure, an antioxidant (C) having a phenolic structure, wherein the entire molecule does not comprise an ester group, and the concentration of antioxidant (C) in the polyolefin composition is at least 1200 ppm, based on the total composition. The compositions show resistance to ClO₂-containing water at 90° C. according to ASTM F2263-03 and reduced phenolic migration into water according to EN-12873-1 at room temperature (23° C.).

EP 2 014 704 A1 relates to a polyolefin composition wherein the migration of the used additives and its decomposition products, especially phenols, out of the composition is low and thus the composition is particularly suitable for pipe applications, e.g. for drinking water. The polyolefin composition comprises a polyolefin (A), a vitamin E-type stabiliser (B) and a phenolic stabilizer (C) and, optionally, an UV stabilizer (D).

EP 1 911 799 A1 relates to a polyolefin composition with increased resistance to degradation caused by ClO₂ containing water and to a pipe made of such a polyolefin composition, wherein an antioxidant used in the polyolefin composition has a low tendency for extraction by the water transported in a pipe. The polyolefin composition comprises a polyolefin base resin and an antioxidant, wherein said polyolefin composition has a lifetime of at least 200 h in a test measuring the resistance against ClO₂ containing water at 90° C. and at a concentration of ClO₂ of 4 ppm wherein the equipment used is according to ASTM F2263-03.

For pipes degraded by chlorine used as the disinfectant it was observed that the antioxidant was consumed by a direct reaction with chlorine. When chlorine dioxide is used as disinfectant it was found that chlorine dioxide is much more aggressive against the pipe polymer material than chlorine. It was found that the antioxidant is rapidly consumed by chlorine dioxide down to a depth of ca. 1 mm. This leaves the polymer unprotected and an oxidation occurs in a layer that is 50-200 μm thick. Due to the stresses in a pipe microcracks will form in the transition from the degraded to the unaffected material and due to the chemical attack in the crack tip the crack will propagate into the material. By the above mechanisms, the time of degradation of polymer materials may be accelerated after the depletion of the antioxidant from the polyolefin composition which should serve as a protection against the attack of the disinfectant in the water with which the polymeric surfaces come into contact.

Hence, there is still a need for improved polyolefin compositions suitable for pipe, fitting or storage applications, particularly for polyolefin compositions having an increased stability in contact with disinfectant containing water.

Thus, it is an object of the present invention to provide an additive for a polyolefin composition useful to manufacture an article, such as a pipe, a fitting or a storage container having an increased resistance against disinfectants, particularly when the polyolefin composition is in permanent contact with disinfectant-containing water.

The present invention is based on the finding that the object of the invention can be achieved by using an acid scavenger as additive.

Therefore, the present invention provides the use of an acid scavenger to increase the resistance of a polyolefin composition against disinfectant containing water.

In the present invention “disinfectant” denotes chlorine and chlorine dioxide.

It has been surprisingly found that using an acid scavenger significantly improves the resistance of polyolefin compositions against disinfectants. Furthermore, it has been found that the pressure stability of pipes made from the composition is retained, i.e. the pressure stability is not negatively affected by the presence of the acid scavenger.

As already stated above, additive providing good chlorine resistance do not necessarily also provide good chlorine dioxide resistance. However, the acid scavenger used in the present invention provides good resistance against both, chlorine as well as chlorine dioxide containing water. Hence, preferably the disinfectant is chlorine dioxide.

Preferably, the acid scavenger is selected from layered double hydroxides (LDHs), metal stearates, metal oxides, metal lactates and metal steaoryl-2-lactylates.

Layered double hydroxides (LDHs) are an unusual class of layered materials with positively charged layers and charge balancing anions located in the interlayer region. This is unusual in solid state chemistry as many more families of materials have negatively charged layers and cations in the interlayer spaces (e.g. kaolinite, Al₂Si₂O₅(OH)₄).

Usually the layered double hydroxides (LDHs) are compounds according to the following formula

[M^{II}₁₋ₓM^{III}ₓ(OH)₂]^{x+}(Aⁿ⁻)_{x/n}.yH₂O

wherein
M^{II} is a divalent metal ion, preferably Mg²⁺, Ca²⁺, Mn²⁺, Fe²⁺, Zn²⁺, Cu²⁺, Ni²⁺ and Co²⁺;
M^{III} is a trivalent metal ion, preferably Al³⁺, Cr³⁺, Fe³⁺, Ga³⁺ and Mn³⁺,
Aⁿ⁻ is an anion, preferably Cl⁻, CO₃²⁻, NO₃⁻, Br⁻, SO₄²⁻ and alkyl sulfonates, alky aryl sulfonates, organic carboxylates, organic phosphates or mixtures thereof, more preferably Cl⁻, CO₃²⁻, NO₃⁻, Br⁻, SO₄²⁻ or mixtures thereof
   whereby n is the number of negative charges, e. g. in case of Cl⁻ n=1 and in case of CO₃²⁻ n=2, usually n is within the range of 1 to 2;
y is number of water molecules needed to stabilize the crystal structure, usually y is within the range of 0.25 to 4, preferably 0.5 to 4, more preferably 0.5 to 1.0;
x is usually within the range of 0.1 to 0.5, preferably within the range of 0.10 to 0.38, more preferably within the range of 0.10 to 0.33;

Layered double hydroxides (LDHs) are inter alia described in F. Cavani, F. Trifiro, A. Vaccari, Catal. Today 1991, 11, 173) which is herewith incorporated by reference.

In case Aⁿ⁻ is an alkyl sulfonates, the alkyl group is usually a C₁ to C₂₀ alkyl group.

In case Aⁿ⁻ is an alky aryl sulfonates the alky aryl group is a C₆ to C₂₀ alky aryl group.

In case Aⁿ⁻ is an organic carboxylate, the organic group attached to the carboxylate group(s) usually contains 1 to 20 carbon atoms and up to 5 heteroatoms, preferably, if present, the heteroatoms are selected from N, O, P and S. Usually the organic carboxylate comprises 1 to 2 carboxylate groups, preferably 1 carboxylate group.

The term “organic group attached to the carboxylate group(s)” denotes that the carboxylate groups are not part of the organic group. Thus, the oxygen and carbon atoms present in the carboxylate group do not count for the organic group. Thus, for example in case of acetate, the organic group is methyl.

In case Aⁿ⁻ is an organic phosphate the organic group(s) attached to the phosphate group(s) independently usually contains 1 to 20 carbon atoms and up to 5 heteroatoms, preferably, if present, the heteroatoms are selected from N, O, P and S. Usually the organic phosphate comprises one phosphate group and one organic group.

The term “organic group(s) attached to the phosphate group(s)” denotes that the phosphate groups are not part of the organic group(s). Thus, the oxygen and phosphor atoms present in the phosphate group do not count for the organic group. Thus, for example in case of methyl phosphate the organic group is methyl.

Preferably, in the layered double hydroxides (LDHs) are compounds according to the following formula

[M^{II}₁₋ₓM^{III}ₓ(OH)₂]^{x+}(Aⁿ⁻)_{x/n}.yH₂O
M^{II} is selected from Mg²⁺, Ca²⁺ or Zn²⁺;
M^{III} is Al³⁺;
Aⁿ⁻ is an anion selected from Cl⁻, CO₃²⁻ and NO₃⁻
y is within the range of 0.25 to 4, preferably within the range of 0.5 to 1.0
x is within the range of 0.10 to 0.38, preferably within the range of 0.10 to 0.33,
   more preferably, the layered double hydroxides (LDHs) is selected from
synthetic hydrotalcit

Mg_{4.5}Al₂(OH)₁₃(CO₃).3.5H₂O (CAS-no. 11097-59-9)
or
hydrotalcit

Mg₆Al₂(OH)₁₆(CO₃).4H₂O.

In case of metal stearates, metal lactates and metal steaoryl-2-lactylates the metal is preferably selected from Li, Na, K, Rb, Cs, Mg, Ca, Sr, Ba, Zn or mixtures thereof, preferably the metal is selected from Ca, Na, K, Mg, Zn or mixtures thereof.

Preferred metal stearates are calcium stearate (CAS-no. 1592-23-0), sodium stearate (CAS-no. 822-16-2) and zinc stearate (CAS-no. 557-05-1).

Preferred metal oxides are magnesium oxide (CAS-no. 1309-48-4) and zinc oxide (CAS-no. 1314-13-2).

A preferred metal lactate is calcium dilactate (CAS-no. 814-80-2).

Preferred steaoryl-2-lactylates are sodium stearoyl-2-lactylate (CAS-no. 25383-99-7) and calcium stearoyl-2-lactylate (CAS-no. 5793-94-2).

Preferably, the acid scavenger is selected from,
metal stearates, the metal being Na, K, Mg or Zn;
metal lactates, the metal being Na, K, Mg or Zn;
metal steaoryl-2-lactylates, the metal being Na, K, Mg or Zn;
magnesium oxide, zinc oxide,
layered double hydroxides (LDHs);
or mixtures thereof,
   more preferably, the acid scavenger is selected from hydrotalcit, synthetic hydrotalcit, calcium stearate, sodium stearate, zinc stearate, magnesium oxide, zinc oxide, calcium dilactate, sodium stearoyl-2-lactylate, calcium stearoyl-2-lactylate and mixtures thereof, even more preferably the acid scavenger is selected from hydrotalcit, synthetic hydrotalcit, calcium stearate, sodium stearate, zinc stearate and mixtures thereof and most preferably, the acid scavenger is selected from hydrotalcit or synthetic hydrotalcit.

As hydrotalcit and synthetic hydrotalcit are minerals only containing carbon in the form of carbonate, no organic decomposition products in case of a reaction with chlorine dioxide can be formed.

Particularly preferred as acid scavenger is synthetic hydrotalcit.

Preferably, the amount of acid scavenger is at least 0.05 wt. % based on the total weight of the polyolefin composition, more preferably, the amount of acid scavenger is at least 0.10 wt. % based on the total weight of the polyolefin composition and most preferably, the amount of acid scavenger is at least 0.15 wt % based on the total weight of the polyolefin composition.

The acid scavenger is preferably present in an amount of not more than 1.5 wt. % based on the total weight of the polyolefin composition, more preferably not more than 1.0 wt. % based on the total weight of the polyolefin composition, even more preferably not more than 0.7 wt. % based on the total weight of the polyolefin composition, even more preferably not more than 0.5 wt. % based on the total weight of the polyolefin composition and most preferably not more than 0.3 wt. % based on the total weight of the polyolefin composition.

Preferably, the acid scavenger is used in combination with an antioxidant (A) according to the following formula (I)

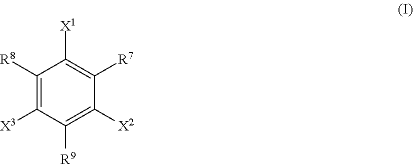

wherein
   R⁷, R⁸ and R⁹ independently are non-substituted or substituted aliphatic or aromatic hydrocarbyl radicals which may comprise heteroatoms,
   X¹, X², and X³ independently are H or OH, with the proviso that at least one of X¹, X² and X³ is OH,
      more preferably, the acid scavenger is a layered double hydroxides (LDHs) and used together with an antioxidant (A) according to formula (I), even more preferably, the acid scavenger is selected from synthetic hydrotalcit or hydrotalcit and used together with an antioxidant (A) according to formula (I).

Optionally, the acid scavenger is used in combination with an antioxidant (A) according to formula (I) and one or more antioxidants according to the following formulas (II) to (IV):
antioxidant (B) with general formula

R¹—P(OAr)₂ (II)
wherein OAr is according to formula (II.A):

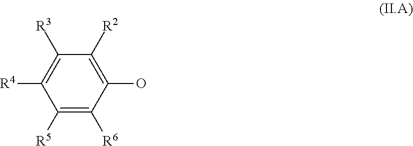

wherein
   R¹ is a non-substituted or substituted aliphatic or aromatic hydrocarbyl radical which may comprise heteroatoms,
   R², R³, R⁴, R⁵ and R⁶ independently are a hydrogen atom or non-substituted or substituted aliphatic or aromatic hydrocarbyl radicals which may comprise heteroatoms;
an antioxidant (C) according to formula (III):

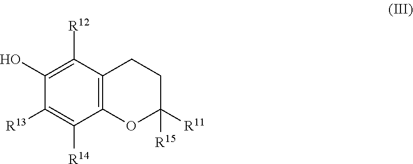

wherein
   R¹¹, R¹², R¹³, R¹⁴ and R¹⁵ independently are H, or non-substituted or substituted aliphatic or aromatic hydrocarbyl radicals which may comprise heteroatoms,
an antioxidant (D) according to formula (IV):

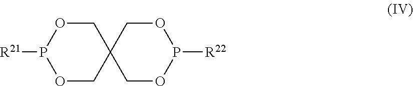

wherein
   R²¹ and R²² each is the same or different residue and comprising at least 6 carbon atoms;
or mixtures thereof.

### Antioxidant A:

If present, the total amount of antioxidants according to formula (I) in the polyolefin composition is preferably from 0.025 to 0.750 wt.-%, more preferably from 0.050 to 0.600 wt.-%, still more preferably from 0.075 to 0.550 wt.-%, based on the total weight of the composition.

Generally antioxidant (A) according to formula (I) may comprise one or more ester groups (A1) or does not comprise any ester group (A2).

Unless otherwise mentioned to the contrary, in the following preferred features of antioxidant (A1) are given.

As already stated above, antioxidant (A1) comprises one or more ester groups.

In antioxidant (A1) residues R⁶, R⁷ and R⁸ independently are non-substituted or substituted aliphatic or aromatic hydrocarbyl radicals which independently may comprise heteroatoms. This means that apart from the at least one ester group in the entire molecule, further heteroatoms or heteroatomic groups may be present.

Preferably, at least one of residues R⁶, R⁷ and R⁸ comprises at least one OH-group. Still more preferably, only one of residues R⁶, R⁷ and R⁸ comprises at least one OH-group, and more preferably the other two residues do not comprise any heteroatom. The latter preferred embodiment means that both the at least one ester group and the at least one OH-group are comprised in the same residue selected from R⁶, R⁷ and R⁸.

Preferably, no further heteroatoms besides oxygen are present in R⁶, R⁷ and R⁸, so that phenolic stabilizer (A1) is e.g. free of amide groups and groups containing phosphorus.

Preferably, R⁶, R⁷ and R⁸ are aliphatic radicals.

Preferably, R⁶, R⁷ and R⁸ independently have from 2 to 200 carbon atoms.

Preferably, R⁶ and R⁷ independently have from 2 to 20 carbon atoms, more preferably from 3 to 10 carbon atoms.

Furthermore, it is preferred that R⁶ and/or R⁷, more preferably R⁶ and R⁷, are aliphatic hydrocarbyl groups with at least 3 carbon atoms which have a branch at the carbon atom connected to the aromatic ring, and most preferably R⁶ and/or R⁷, more preferably R⁶ and R⁷, are tert.-butyl groups.

Preferably, R⁸ has from 20 to 100 carbon atoms, more preferably has from 30 to 70 carbon atoms.

Furthermore, it is preferred that R⁸ includes one or more phenyl residues.

Still further, it is preferred that R⁸ includes one or more hydroxyphenyl residues.

In the most preferred embodiment, R⁸ is a Pentaerythrityl-tris(3-(3′,5′-di-tert. butyl-4-hydroxyphenyl)propionate)-3-propionate residue.

Preferably, in antioxidant (A1) X¹ is OH, and most preferably X¹ is OH and X² and X³ are H.

It is particularly preferred that antioxidant (A1) is Pentaerythrityl-tetrakis(3-(3′,5′-di-tert. butyl-4-hydroxyphenyl)propionate) (Irganox 1010).

Unless otherwise mentioned to the contrary, in the following preferred features of antioxidant (A2) are given.

As already stated above, antioxidant (A2) does not comprise any ester group.

In antioxidant (A2) residues R⁷, R⁸ and R⁹ independently are non-substituted or substituted aliphatic or aromatic hydrocarbyl radicals which may comprise OH-groups. This means that apart from OH-groups no further heteroatoms are present in R⁷, R⁸ and R⁹, so that phenolic stabilizer (A2) is e.g. free of ester groups, amide groups and groups containing phosphorus.

Preferably, R⁷, R⁸ and R⁹ which independently are non-substituted or substituted aliphatic or aromatic, more preferably aliphatic, hydrocarbyl radicals which may comprise OH-groups, have from 2 to 200 carbon atoms.

Preferably, R⁷ and R⁸ independently have from 2 to 20 carbon atoms, more preferably from 3 to 10 carbon atoms.

Furthermore, it is preferred that R⁷ and/or R⁸, more preferably R⁷ and R⁸, are aliphatic hydrocarbyl groups, more preferably alkyl radicals, still more preferably with at least 3 carbon atoms which have a branch at the carbon atom connected to the aromatic ring, and most preferably R⁷ and/or R⁸, more preferably R⁷ and R⁸, are tert-butyl groups.

Preferably, R⁹ has from 20 to 100 carbon atoms, more preferably has from 30 to 70 carbon atoms.

Furthermore, it is preferred that R⁹ includes one or more phenyl residues.

Still further, it is preferred that R⁹ includes one or more hydroxyphenyl residues.

Preferably, in antioxidant (A2) X¹ is OH, and most preferably X¹ is OH and X² and X³ are H.

It is particularly preferred that antioxidant (A2) is 1,3,5-Tri-methyl-2,4,6-tris-(3,5-di-tert. butyl-4-hydroxyphenyl)benzene (Irganox 1330).

### Antioxidant B:

R¹ preferably is an aliphatic or aromatic hydrocarbyl radical, wherein the heteroatoms present are selected from oxygen, nitrogen and phosphor atoms.

In case of at least one phosphor atom it is particularly preferred that R¹ is directly attached to the phosphor atom of formula R¹—P(OAr)₂ via a carbon atom of an aromatic hydrocarbyl radical which itself is directly attached to a further phosphor atom of a further group P(OAr)₂ via a different carbon atom of said aromatic hydrocarbyl radical, i.e. R¹ is an aromatic hydrocarbyl radical bridging two P(OAr)₂-groups.

Preferably, the amount of carbon atoms in said bridging aromatic hydrocarbyl radical is between 6 and 25, more preferably between 6 and 20.

In an alternative particularly preferred embodiment R¹ is an aliphatic or aromatic hydrocarbyl radical wherein the only heteroatoms present are oxygen atoms, one of which connects R¹ with the phosphor atom of the P(OAr)₂-group. Still more preferably, said oxygen atom is the only heteroatom present in R¹.

In the above-mentioned alternative preferred embodiment it is further preferred that R¹ comprises between 1 and 20 carbon atoms, more preferably between 2 and 16 carbon atoms.

In said alternative preferred embodiment it is further preferred that apart from said connecting oxygen atom R¹ does not comprise a further heteroatom and said oxygen atom connects an aromatic hydrocarbyl radical with the P(OAr)₂-group.

In said alternative preferred embodiment it is further preferred that apart from said connecting oxygen atom R¹ does not comprise a further heteroatom and said oxygen atom connects an aromatic hydrocarbyl radical with the P(OAr)₂-group, still more preferably R¹ is OAr as defined herein.

R², R³, R⁴, R⁵ and R⁶ preferably comprise between one carbon atom and 20 carbon atoms each, more preferably not more than 10 carbon atoms each.

Preferably, R², R³, R⁴, R⁵ and R⁶ do not comprise any heteroatom.

Preferably, R², R³, R⁴, R⁵ and R⁶ are a hydrogen atom or aliphatic hydrocarbyl radicals, more preferably alkyl radicals. Even more preferred is that at least one of R², R⁴ and R⁶ is an alkyl radical, more preferably with one to four carbon atoms, more preferably a methyl group or a tert-butyl group. Still more preferably, R³ and R⁵ are hydrogen atoms.

In a particular preferred embodiment at least two of R², R⁴ and R⁶ are a tert-butyl group, preferably R² and R⁴ are tert-butyl groups.

It is further preferred that R², R³, R⁴, R⁵ and R⁶ is the same in the P(OAr)₂-group and in the preferred embodiment wherein R¹ is OAr as defined herein.

A particular preferred antioxidant (B) is tris(2,4-di-t-butylphenyl)phosphite (Irgafos 168).

If present, the total amount of antioxidants according to formula (II) in the polyolefin composition is preferably from 0.025 to 0.300 wt.-%, more preferably from 0.050 to 0.225 wt.-%, still more preferably from 0.075 to 0.175 wt.-%, based on the total weight of the composition.

### Antioxidant C:

The heteroatoms which may be present in the non-substituted or substituted aliphatic or aromatic hydrocarbyl radicals R¹¹, R¹², R¹³, R¹⁴ and/or R¹⁵ of antioxidant (C) according to formula (III) may be oxygen, sulphur, nitrogen, phosphorus or the like. It is, however, preferred that R¹¹, R¹², R¹³, R¹⁴ or R¹⁵, more preferred R¹¹, R¹², R¹³, R¹⁴ and R¹⁵, do not comprise heteroatoms, i.e. are non-substituted or substituted aliphatic or aromatic hydrocarbyl radicals only, or, as mentioned, H.

Furthermore, preferably R¹², R¹³, R¹⁴ or R¹⁵, more preferably R¹², R¹³, R¹⁴ and R¹⁵, are H, or saturated aliphatic hydrocarbyl radicals comprising from 1 to 5 carbon atoms, and still more preferably R¹², R¹³, R¹⁴ or R¹⁵, more preferably R¹², R¹³, R¹⁴ and R¹⁵, are H, or methyl groups.

Furthermore, preferably R¹⁵ is a methyl group, regardless of the nature of the other residues R¹² to R¹⁴.

In an especially preferred embodiment, R¹⁴ and R¹⁵ are methyl groups, and R¹² and R¹³ are H, or methyl groups.

Most preferably, R¹², R¹³, R¹⁴ and R¹⁵ are all methyl groups.

Still further, preferably R¹¹ is a non-substituted or substituted aliphatic or aromatic hydrocarbyl radical containing from 5 to 50 carbon atoms, more preferably R¹¹ is a non-substituted or substituted aliphatic hydrocarbyl radical containing from 5 to 50, more preferably from 10 to 30, carbon atoms, and most preferably R¹ is a 4,8,12-trimethyl-tridecyl group.

Still more preferred, antioxidant (C) is 2,5,7,8-Tetramethyl-2-(4′,8′,12′-trimethyltridecyl)chroman-6-ol (Irganox® E 201 or Vitamin E).

If present, the total amount of antioxidants according to formula (III) in the polyolefin composition is preferably from 0.010 to 0.200 wt.-%, more preferably from 0.015 to 0.100 wt.-%, still more preferably from 0.020 to 0.075 wt.-%, based on the total weight of the composition.

### Antioxidant D:

It is preferred that in formula (IV) of compound (D) R²¹ and R²² each is the same or different residue and comprise preferably at least 10 C-atoms.

Preferably, R²¹ and R²² do not comprise more than 100 carbon atoms each, more preferably, R²¹ and R²² do not comprise more than 50 carbon atoms each and most preferably R²¹ and R²² do not comprise more than 30 carbon atoms each.

Preferably, in formula (IV) R²¹ and/or R²² is R²³—O—, the oxygen atom being connected to the phosphorus atom of formula (IV) more preferably R²¹ and R²² are R²³—O—, the oxygen atom being connected to the phosphorus atom of formula (IV). Preferably, R²³ comprises at least 6 carbon atoms, more preferably at least 10 carbon atoms. Preferably, R²³ does not comprise more than 100 carbon atoms each.

Preferably, R²¹, R²² and/or R²³ comprise at least one aryl group.

In a particular preferred embodiment of the present invention compound (D) is Bis(2,4-dicumylphenyl)pentaerythritol-di-phosphite (Doverphos S-9228 CT) or Bis(2,6-di-t-butyl-4-methylphenyl)pentaerythrityl-di-phosphite (ADK STAB PEP-36).

If present, the total amount of antioxidants according to formula (IV) in the polyolefin composition is preferably from 0.025 to 0.300 wt.-%, more preferably from 0.050 to 0.225 wt.-%, still more preferably from 0.075 to 0.175 wt.-%, based on the total weight of the composition.

The total amount of antioxidants in the polyolefin composition is preferably at least 0.20 wt. %, more preferably at least 0.30 wt. % and most preferably at least 0.40 wt. % based on the total weight of the composition.

Preferably, the total amount of antioxidants in the polyolefin composition is preferably not more than 1.0 wt. %, more preferably not more than 0.75 wt. % and most preferably not more than 0.50 wt. % based on the total weight of the composition.

In case antioxidants different from compounds according to formulas (I), (II), (III) and (IV) are present, they are usually present in an amount of 0.25 wt. % based on the total weight of the composition.

However, usually and preferably, only antioxidants according to formulas (I), (II), (III) and (IV) are present in the polyolefin composition.

Preferably, at least two antioxidants are used, more preferably, at least one antioxidant (A) according to formula (I) is used and at least one antioxidant selected from antioxidants according to formulas (II), (III) and/or (IV). Usually not more than four different antioxidants according to formulas (I), (II), (III) and (IV) are present in the polyolefin composition, preferably, not more than three different antioxidants according to formulas (I), (II), (III) and (IV) are present in the polyolefin composition. In case antioxidants not according to formulas (I), (II), (III) and (IV) are present in the polyolefin composition usually not more than two of such antioxidants are present in the polyolefin composition. In a preferred embodiment only antioxidants according to formulas (I), (II), (III) or (IV) are used.

Usually only one antioxidant (A) according to formula (I) is present. However, in case more than one antioxidant (A) according to formula (I) is present, preferably all antioxidants (A) according to formula (I) comprise at least one ester group (A1) or all antioxidants (A) according to formula (I) do not comprise any ester groups (A2).

Furthermore, if present, usually either an antioxidants according to formula (II) (antioxidant B) or according to formula (IV) (antioxidant D) are present in the polyolefin composition. Hence, in case an antioxidant (B) is present preferably no antioxidant (D) is present in the polyolefin composition and in case an antioxidant (D) is present preferably no antioxidant (B) is present in the polyolefin composition.

A particular preferred combination of antioxidants is one or more antioxidant(s) (B) and one or more antioxidants (A2), e.g. tris(2,4-di-t-butylphenyl)phosphite (Irgafos 168) and 1,3,5-Tri-methyl-2,4,6-tris-(3,5-di-tert. butyl-4-hydroxyphenyl)benzene (Irganox 1330).

Another particular preferred combination of antioxidants is one or more antioxidant(s) (C) and one or more antioxidants (A1), e.g. 2,5,7,8-Tetramethyl-2-(4′,8′,12′-trimethyltridecyl)chroman-6-ol (Irganox® E 201 or Vitamin E) and Pentaerythrityl-tetrakis(3-(3′,5′-di-tert. butyl-4-hydroxyphenyl)propionate) (Irganox 1010).

The term “base resin” denotes the entirety of polymeric components in the polyolefin composition according to the invention, usually making up at least 90 wt % of the total polyolefin composition.

The favorable effect of the antioxidants according to the present invention is not dependent on the type of polyolefin base resin used. The base resin may therefore be any polyolefin or polyolefin composition.

However, it is preferred that the base resin comprises an olefin polymer comprising at least one olefin having 2 to 8 carbon atoms. At least one ethylene homo- or copolymer or a propylene homo- or copolymer are especially preferred. Preferably, the comonomer is selected from ethylene, propylene and alpha-olefins with 4 to 8 carbon atoms. Still more preferably ethylene, propylene or an alpha-olefin selected from 1-butene, 1-hexene, 4-methyl-1-pentene and 1-octene is used as the comonomer.

The amount of comonomer in the base resin is preferably between 0.1 mol % and 7.0 mol %.

It is particularly preferred that the base resin comprises an ethylene homo- or copolymer or a propylene homo- or copolymer, more preferably the total amount of ethylene homo- or copolymers and propylene homo- or copolymers is at least 80 wt. % of the base resin, even more preferably at least 90 wt. % of the base resin, and most preferably the base resin consists of an ethylene homo- or copolymer or a propylene homo- or copolymer.

In one embodiment of the invention the base resin comprises two or more polyolefins, more preferably polyethylene fractions with different weight average molecular weight. Such resins usually are denoted as multimodal resins.

Polyolefin, in particular polyethylene compositions comprising unimodal or multimodal or crosslinked resins are frequently used e.g. for the production of pipes and fittings due to their favourable physical and chemical properties as e.g. mechanical strength, corrosion resistance and long-term stability. Such compositions are described e.g. in EP 0 739 937 and WO 02/102891. The term molecular weight used herein generally denotes the weight average molecular weight M_{w}.

As mentioned, usually a polyethylene composition comprising at least two polyethylene fractions, which have been produced under different polymerisation conditions resulting in different weight average molecular weights for the fractions, is referred to as “multimodal”. The prefix “multi” relates to the number of different polymer fractions the composition is consisting of. Thus, for example, a composition consisting of two fractions only is called “bimodal”.

The form of the molecular weight distribution curve, i.e. the appearance of the graph of the polymer weight fraction as function of its molecular weight, of such a multimodal polyethylene will show two or more maxima or at least be distinctly broadened in comparison with the curves for the individual fractions.

For example, if a polymer is produced in a sequential multistage process, utilising reactors coupled in series and using different conditions in each reactor, the polymer fractions produced in the different reactors will each have their own molecular weight distribution and weight average molecular weight. When the molecular weight distribution curve of such a polymer is recorded, the individual curves from these fractions are superimposed into the molecular weight distribution curve for the total resulting polymer product, usually yielding a curve with two or more distinct maxima.

In a preferred embodiment wherein the base resin consists of two polyethylene fractions, the fraction having a lower weight average molecular weight is denoted LMW (low molecular weight fraction), the other is denoted HMW (high molecular weight fraction.

The LMW is preferably is an ethylene homopolymer.

The HMW is preferably is an ethylene copolymer, and preferably comprises at least 0.1 mol % of at least one alpha-olefin comonomer. The amount of comonomer is preferably at most 14 mol %.

In a preferred embodiment wherein the polyolefin composition is a polyethylene composition, the base resin of the polyethylene composition preferably comprises at least 0.1 mol %, more preferably at least 0.3 mol %, and still more preferably at least 0.7 mol % of at least one alpha-olefin comonomer. The amount of comonomer is preferably at most 7.0 mol %, more preferably at most 6.0 mol %, and still more preferably at most 5.0 mol %.

As an alpha-olefin comonomer, preferably an alpha-olefin having from 4 to 8 carbon atoms is used. Still more preferably an alpha-olefin selected from 1-butene, 1-hexene, 4-methyl-1-pentene and 1-octene is used.

The polyolefin base resin preferably has an MFR₅ (190° C., 5 kg) of from 0.01 to 5.0 g/10 min, more preferably from 0.1 to 2.0 g/10 min, still more preferably from 0.2 to 1.5 g/10 min, and most preferably from 0.5 to 1.0 g/10 min.

The density of the base resin preferably is from 920 to 960 kg/m³, more preferably is from 930 to 958 kg/m³, and most preferably is from 936 to 955 kg/m³.

In addition to the base resin and the antioxidants, usual additives for utilization with polyolefins, such as pigments (for example carbon black), stabilizers, antistatic agents and utilization agents (such as processing aid agents) may be present in the polyolefin composition.

The amount of such additives usually is 10 wt % or below.

Carbon black is a generally used pigment, which also acts as an UV-absorber. Typically carbon black is used in a final amount of from 0.5 to 5% by weight, preferably from 1.5 to 3.0% by weight. Preferably the carbon black is added as a masterbatch, i.e. Carbon black master batch (CBMB) where it is premixed with a polymer, preferably polyethylene, in a specific amount as e.g. shown in the Examples.

The polymerisation catalysts for the production of the base resin include coordination catalysts of a transition metal, such as Ziegler-Natta (ZN), metallocenes, non-metallocenes, Cr-catalysts etc. The catalyst may be supported, e.g. with conventional supports including silica, Al-containing supports and magnesium dichloride based supports. Preferably the catalyst is a ZN catalyst, more preferably the catalyst is a non-silica supported ZN catalyst, and most preferably a MgCl₂-based ZN catalyst.

The Ziegler-Natta catalyst further preferably comprises a group 4 (group numbering according to new IUPAC system) metal compound, preferably titanium, magnesium dichloride and aluminum.

The catalyst may be commercially available or be produced in accordance or analogously to the literature. For the preparation of the preferable catalyst usable in the invention, reference is made to WO 2004/055068 and WO 2004/055069 of Borealis and EP 0 810 235. The content of these documents in its entirety is incorporated herein by reference, in particular concerning the general and all preferred embodiments of the catalysts described therein as well as the methods for the production of the catalysts. Particularly preferred Ziegler-Natta catalysts are described in EP 0 810 235.

The composition is preferably produced in a process comprising a compounding step, wherein the base resin which is typically obtained as a powder from the reactor, together with the acid scavenger and optionally antioxidants (A) to (D) and/or other additives is extruded in an extruder to yield the composition according to the present invention.

Of course, when using the inventive composition, further compounds selected from conventional additives, such as stabilizers, modifiers, fillers, minerals and lubricants may be added for improving processability and surface characteristics thereof.

The use according to the present invention is particularly suitable for pipes, tapes, films, sheets, fittings or storage containers. The use is especially suitable for pipes, fittings or storage containers for drinking water distribution systems comprising the polyolefin composition.

Hence, preferably, the acid scavenger is used to increase the resistance of pipes, fittings or storage containers for drinking water distribution systems comprising the polyolefin composition as described in the present invention against chlorine dioxide containing water.

In a preferred embodiment the present invention is directed to the use of layered double hydroxides (LDHs) are compounds according to the following formula

[M^{II}₁₋ₓM^{III}ₓ(OH)₂]^{x+}(Aⁿ⁻)_{x/n}.yH₂O
M^{II} is selected from Mg²⁺, Ca²⁺ or Zn²⁺;
M^{III} is Al³⁺;
Aⁿ⁻ is an anion selected from Cl⁻, CO₃²⁻ and NO₃⁻
y is within the range of 0.25 to 4, preferably within the range of 0.5 to 1.0
x is within the range of 0.10 to 0.38, preferably within the range of 0.10 to 0.33,
   more preferably the layered double hydroxides (LDHs) is selected from
synthetic hydrotalcit

Mg_{4.5}Al₂(OH)₁₃(CO₃).3.5H₂O (CAS-no. 11097-59-9)
or
hydrotalcit

Mg₆Al₂(OH)₁₆(CO₃).4H₂O

to increase the resistance of a polyolefin composition against chlorine dioxide containing water
wherein the entirety of polymeric components in the polyolefin composition (“base resin”) according to the invention, is making up at least 90 wt % of the total polyolefin composition and the base resin comprises an ethylene homo- or copolymer or a propylene homo- or copolymer as defined above.

The present invention further relates to a method for transporting water containing chlorine dioxide comprising the step of conveying the water through a pipe comprising a polyolefin composition, the polyolefin composition comprising an acid scavenger.

The acid scavenger provides an improved resistance against disinfectants, particularly chlorine dioxide, as can be seen from the results of the reverse bend back test (RBBT) described in detail in the experimental part.

In this test the inner surface of the pipe is observed under a light microscope. The number of cracks and crazes shows the grade of deterioration of the inner surface of the pipe.

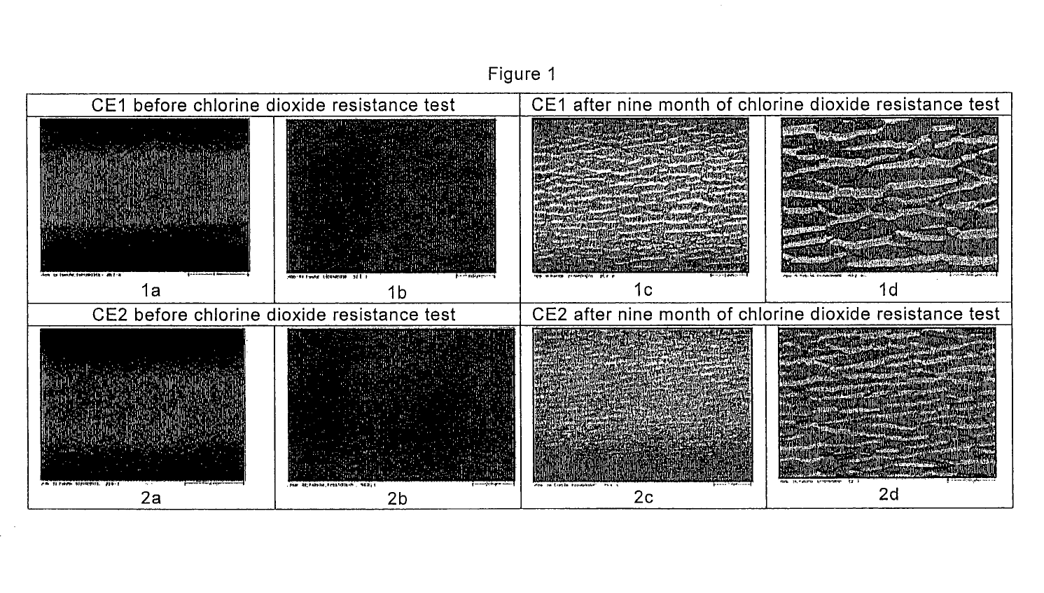

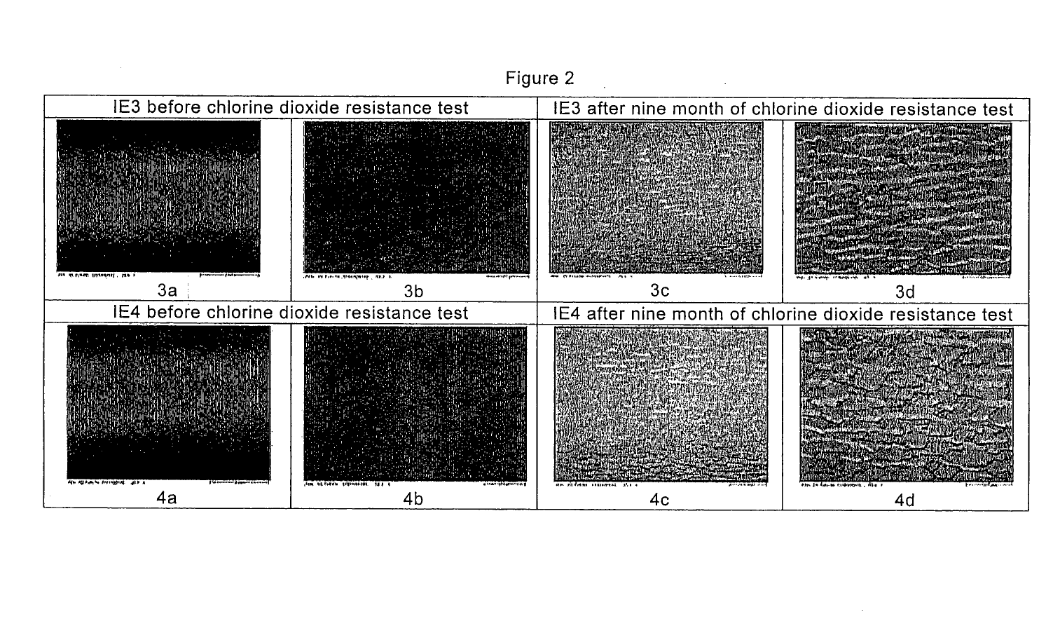

FIGS. 1 and 2 show the surface of samples of the polyolefin composition prior and after chlorine dioxide treatment.

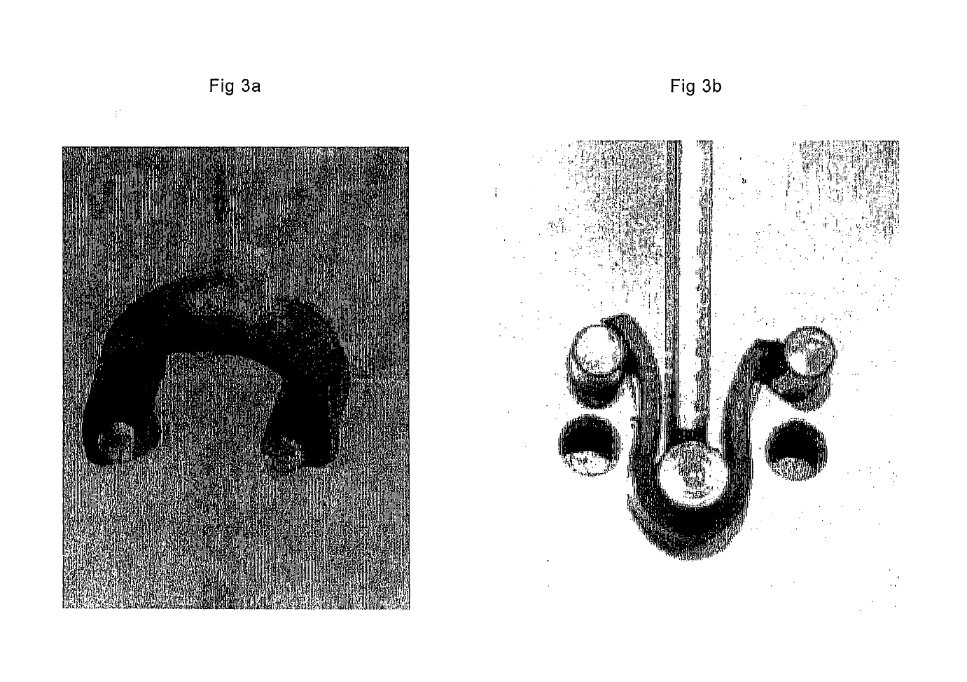

FIG. 3a shows the form of the 240° sector (specimen) of the pipe prior to the bending for the bend back test (RBBT) described in the experimental section.

FIG. 3b shows the form of the 240° sector (specimen) of the pipe after the bending for the bend back test (RBBT) described in the experimental section.

The invention will now be described by the following non-limiting examples.

### EXAMPLES

### Measurement Methods

### Chlorine Dioxide Resistance

The compositions to be tested are formed into pipes having an outer diameter of 25 mm, a wall thickness of 2.3 mm and a length of 1 meter by a Battenfeld extruder for PE materials.

The extrusion condensations were as follows. Melt temperature: 213° C., torque 42-45%, screw speed 27 rpm, output 19 kg/h.

The following temperature profile was applied for pipe extrusion:

| | Inlet | Cylinder | | | Pipe Head | | | | | Die |
|---|---|---|---|---|---|---|---|---|---|---|
| Zone | 0 | 1 | 2 | 3 | 1 | 2 | 3 | 4 | 5 | 6 |
| [° C.] | 49 | 175 | 180 | 185 | 195 | 195 | 195 | 195 | 195 | 195 |

The pipes are subjected to water containing chlorine dioxide in a concentration of 1 mg/l+/−0.05 at a pressure of 0.6 MPa and a temperature of 40° C. The flow rate of the water was 200 liter/hour. The chlorine dioxide concentration was monitored and controlled during the measurement.

### Reverse Bend Back Test (RBBT)

In this test pipes samples subjected for 270 days to the above chlorine dioxide test were subjected to the following procedure:

The Reverse Bend Back Test is a pipe characterisation method which was designed for detecting on field the degradation status on pipes in service. It was recently developed, according to the guideline from the standard ASTM D 2513 in order to get more information regarding the degradation status of pipes from the semi-pipe testing program.

The specimen is prepared as follows.

A ring having a length of 20 mm is cut from the pipe perpendicular to the flow direction. A 240° sector is then cut from the resulting ring. This 240° sector is then deformed to turn the inside out. The form of the specimen prior to and after the bending is depicted in FIG. 3.

The inner surface of the pipe (marked with an arrow in FIG. 3) is observed under a light microscopy. The morphology of the bended inner surface supplies information on how severe or not the degradation is.

### Density

Density is measured according to ISO 1183-1:2004 (method A) on compression moulded specimen prepared according to EN ISO 1872-2 (February 2007) and is given in kg/m³.

### Melt Flow Rate

The melt flow rate (MFR) is determined according to ISO 1133 and is indicated in g/10 min. The MFR is an indication of the flowability, and hence the processability, of the polymer. The higher the melt flow rate, the lower the viscosity of the polymer. The MFR is determined at 190° C. for polyethylene and determined at a loading of 5.00 kg (MFR₅).

### Pressure Test: Control Point (ISO 1167)

The pressure test on un-notched 25 mm×2.3 mm pipes having a length of 350 mm is carried out in water-inside and water-outside environment. End caps were used. Control time is determined in hours. A hoop stress of 4.0 MPa and a temperature of 80° C. were applied. It is subjected to check whether the developed materials pass the control point in pressure pipe testing.

The minimum pipe wall thickness is measured according to ISO3126.

### Used Polymer

PE resin used for compounding has a bulk density of 951 kg/m³ with an MFR₅ (ISO 1133, 190° C., 5.0 kg) of 0.85 g/10 min.

| | |
|---|---|
| Irganox 1010 | Pentaerythrityl-tetrakis(3-(3′,5′-di-tert. butyl-4-hydroxy- |
| | phenyl)propionate) |
| Irganox 1330 | 1,3,5-tri-methyl-2,4,6-tris-(3,5-di-tert. butyl-4-hydroxy- |
| | phenyl) benzene |
| Irgafos 168 | Tris(2,4-di-tert. butylphenyl)phosphite |
| Irganox E201 | 2,5,7,8-Tetrametyl-2-(4′,8′,12′-trimethyltridecyl)- |
| | chroman-6-ol (Vitamin E) |
| Ca stearate | obtained by Faci. |

### Carbon Black Masterbatch (CBMB):

A masterbatch containing 39.5 wt. % carbon black (Elftex TP, distributed by Cabot) and 60.4 wt. % of an ethylene-butylene copolymer having a comonomer content of 1.7 wt. %, an MFR₂ (2.16 kg, 190° C., ISO 1133) of 30 g/10 min and a density of 959 kg/m³ has been used.

hydrotalcit: Pural MG63HT obtained from Sasol

### Compounding

Compositions having the content as indicated in table 1 below were prepared by a co-rotating twin screw extruder Coperion ZSK40 (L/D 43). The screw speed can be set between 150-200 rpm, torque 80-85% and throughput rate ˜50-55 kg/h. Temperature profile was set at 190-200° C.”

TABLE 1

| | CE1 | CE2 | IE3 | IE4 |
|---|---|---|---|---|
| PE resin | 93.88 | 93.635 | 93.350 | 93.435 |
| Irganox 1010 | 0.11 | 0.32 | | 0.32 |
| Irganox. | | | 0.32 | |
| 1330 | | | | |
| Irgafos 168 | 0.11 | | 0.11 | |
| Irganox | | 0.025 | | 0.025 |
| E201 | | | | |
| Ca-Stearate | 0.15 | 0.15 | 0.15 | 0.15 |
| CBMB | 5.75 | 5.75 | 5.75 | 5.75 |
| Hydrotalcit | | | 0.200 | 0.200 |

### CE: Comparative Example; IE: Inventive Example

The materials have been subjected to the above described test for chlorine dioxide resistance. The results are shown in table 2.

TABLE 2

| Material | Time to failure (days) |
|---|---|
| CE1 | 324 |
| CE2 | 346 |
| IE3 | >580 (test still running) |
| IE4 | 408 |

Two samples of each pipe have been subjected to the reverse bend back test (RBBT) as described above. The results are shown in FIGS. 1 and 2.

1a and 1b show the two pipe samples of comparative example 1 prior to the chlorine dioxide test and 1c and 1d show the two samples 1a and 1b, respectively after 270 days of the test.

2a and 2b show the two pipe samples of comparative example 2 prior to the chlorine dioxide test and 2c and 2d show the two samples 2a and 2b, respectively after 270 days of the test.

3a and 3b show the two pipe samples of inventive example 3 prior to the chlorine dioxide test and 3c and 3d show the two samples 3a and 3b, respectively after 270 days of the test.

4a and 4b show the two pipe samples of inventive example 4 prior to the chlorine dioxide test and 4c and 4d show the two samples 4a and 4b, respectively after 270 days of the test.

As can be seen from the figures no cracks or crazes were present on the inner surfaces of the pipes prior to exposure to chlorine dioxide containing water.

Furthermore, as can be seen when comparing FIGS. 1c/1d with 3c/3d and 2c/2d with 4c/4d the stability using the inventive stabilizer is significantly improved.

Furthermore, two pipes of each of the above examples having an outside diameter of 24.9 mm have been subjected to pressure testing according to IS01167 as described above at a temperature of 80° C. and a hoop stress of 4 MPa. The measurement was stopped at the test time given in table 3 whereby no failure was observed.

The results from pressure pipe testing show that the pressure resistance is not affected by adding the acid scavenger to the PE materials

TABLE 3

| | Hoop stress | Average Test time without failure |
|---|---|---|
| | (MPa) | (hours) |
| CE1 | 4.0 | 5423 |
| CE2 | 4.0 | 5619 |
| IE3 | 4.0 | 5545 |
| IE4 | 4.0 | 5607 |

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. Method for transporting water containing chlorine dioxide comprising the step of conveying the water through a pipe comprising a polyolefin composition, the polyolefin composition comprising an acid scavenger selected from layered double hydroxides (LDHs), metal oxides, metal lactates and metal steaoryl-2-lactylates.

14. The method according to claim 13, wherein the acid scavenger is hydrotalcit.

15. The method according to claim 13, wherein the amount of acid scavenger is 0.05 to 1.5 wt. % of the polyolefin composition.

16. The method according to claim 13, wherein the entirety of polymeric components in the polyolefin composition (“base resin”) is making up at least 90 wt % of the total polyolefin composition.

17. The method according to claim 16, wherein the base resin comprises an ethylene homo- or copolymer or a propylene homo- or copolymer.

18. The method according to claim 17, wherein total amount of ethylene homo- or copolymers and propylene homo- or copolymers is at least 80 wt. % of the base resin.

19. The method according to claim 13, wherein the acid scavenger is used in combination with an antioxidant (A) according to the following formula (I) 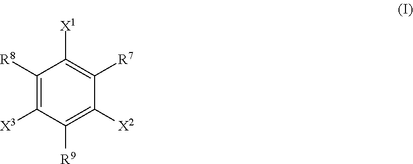
wherein
R⁷, R⁸ and R⁹ independently are non-substituted or substituted aliphatic or aromatic hydrocarbyl radicals which may comprise heteroatoms,
X¹, X², and X³ independently are H or OH, with the proviso that at least one of X¹, X² and X³ is OH.

20. The method according to claim 19, wherein the acid scavenger is used in combination with an antioxidant (A) according to formula (I) and one or more antioxidants according to the following formulas (II) to (IV):
antioxidant (B) with general formula (II)
R¹—P(OAr)₂ (II)
wherein OAr is according to formula (II.A): 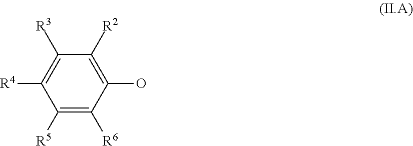
wherein
R¹ is a non-substituted or substituted aliphatic or aromatic hydrocarbyl radical which may comprise heteroatoms,
R², R³, R⁴, R⁵ and R⁶ independently are a hydrogen atom or non-substituted or substituted aliphatic or aromatic hydrocarbyl radicals which may comprise heteroatoms;
an antioxidant (C) according to formula (III): 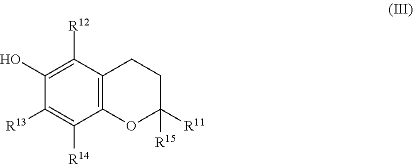
wherein
R¹¹, R¹², R¹³, R¹⁴ and R¹⁵ independently are H, or non-substituted or substituted aliphatic or aromatic hydrocarbyl radicals which may comprise heteroatoms,
an antioxidant (D) according to formula (IV): 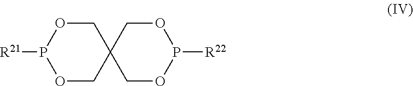
wherein
R²¹ and R²² each is the same or different residue and comprising at least 6 carbon atoms;
or mixtures thereof.

21. The method according to claim 19, wherein at least one antioxidant (A) according to formula (I) is used and at least one antioxidant selected from antioxidants (B), (C) and (D).

22. The method according to claim 20, wherein at least one antioxidant (A) according to formula (I) is used and at least one antioxidant selected from antioxidants (B), (C) and (D).
